(19) United States
(12) Patent Application Publication
(10) Pub. No.: US 2003/0016896 A1
(43) Pub. Date: Jan. 23, 2003

(54) Electro-optic waveguide devices

(76) Inventors: Bahman Azarbar, Ottawa (CA); Feng Yuan Gan, Ottawa (CA); Hamid Hatami-Hanza, Ottawa (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/970,798

(22) Filed: Oct. 5, 2001

(30) Foreign Application Priority Data
Jul. 20, 2001 (US) 09/908,673

(51) Int. Cl. G02F 1/035

(52) U.S. Cl. 385/2; 385/129

(57) ABSTRACT

In an optical planar waveguide device, the electrodes which modulate a section of the waveguide, say to alter its refractive index, are coplanar with, and positioned on either side of, the waveguide section, which improves modulating efficiency.

### BACKGROUND OF INVENTION

1. Field of Invention

The present invention relates, in general, to the design of optical waveguide devices and specifically to the design of the electrodes of such devices. The electrodes are intended to change the characteristics of electro-optic material used for forming the planar channel-waveguides in optical devices such as switches, couplers, intensity modulators, phase shifters, and so forth.

2. Prior Art of the Invention

Optical switches and modulators made of electro-optic material are the key building blocks in the design of high-speed optical communications networks. As migration continues to all-optical devices utilizing a large number of these building blocks within a single optical device or circuit, their performance is essential in achieving the design objectives in terms of a smaller overall volume for a device or circuit, lower required voltage and power, less dissipated power, wider information bandwidth and smaller inter-channel cross-talk.

Electro-optic devices utilizing materials such as Lithium Niobate rely on the controlled change of the refraction index of the electro-optic material through application of an external electric field. The electric field is set up by the application of a voltage source (constant voltage or time varying signal) to a series of electrodes (conductors) placed near the electro-optic material forming optical channel-waveguide(s). The change in the refraction index results in changing the phase of the light propagating in the optical channel relative to a reference state (such as a component of the same light propagating in a parallel channel). Such relative changes can be productively utilized to design optical switches, optical modulators and optical phase shifters; just to name a few.

For a given level of desired relative phase shift, the efficiency with which this external electric field is set up controls the required voltage and the length of the optical channel and, hence, the figure-of-merit of such optical devices in terms of Voltage-Length product (V_{π}×L). This efficiency is keenly related to the geometry and configuration of the electrodes relative to the light carrying channels. For high-speed applications, another important factor in the design of the electrodes is the propagation speed of the modulating (microwave) signal relative to the optical mode along the guiding-channel(s). The differential propagation speed will ultimately dictate the amount of information that can be transmitted through the channels (bandwidth). As a result, in such applications, the design motivation is not only to strive to minimize V_{π}×L but also to ensure that the highest bandwidth is achieved. Yet another factor controlling the performance of the high-speed optical device is the attenuation of the composite signal along the optical channel(s). Such attenuation not only adversely affects the device's insertion loss, the required prime power and dissipated power, but also lowers the channel cutoff frequency.

A more efficient electrode design will result in a lower V_{π}×L, which in turn can be used productively to reduce channel-length. This in turn reduces the physical size, microwave and optical losses, the required prime power and dissipated power, and increases the transmission bandwidth. Alternatively, it can be used to lower the voltage, which in turn reduces the required prime power and dissipated power. Usually a combination of these two options is exercised in a practical design tradeoff.

Electrode design for excitation of the electro-optic material has taken many forms in the past two decades. It started by very thin surface-mount electrodes configured on the two sides of the guiding channels or located on top. To maximize the electro-optic effects, in the case of channels made of LiNbO3 as electro-optic material, horizontal field excitation of the channel-waveguide is mostly suited for x-cut crystals and vertical field excitation is mostly suited for z-cut crystals.

The electric field generated by such a thin structure is fairly non-uniform and highly localized around the edges of the electrodes, with the magnitude of the field rapidly decaying as one moves away from the electrode edges. For a given voltage applied between an electrode pair (DC or time varying voltage), field intensity increases as the separation distance between the edges of the two electrodes diminishes. However, field remains highly non-uniform and mostly concentrated in the dielectric-air interface and around the edges. As the edges of the electrodes become closer, the electric charges (for static field) or electric currents (for time varying fields) interact increasing conductor losses and making impedance matchnig difficult (edge effects). Furthermore, for time-varying field, the cutoff frequency is relatively low due to a combination of the skin-depth effect (high conductance loss at higher frequencies) and the propagation speed differences along the guiding channels between the modulating signal and the optical mode.

For high-speed applications, single, double or multilayered thick electrode designs have been proposed (prior art) to reduce the skin-effect conductor losses and the differential propagation speed as experienced by the modulating signal. The favored configuration for this type of arrangement is vertical field excitation (principally vertical) by placing the electrodes on top of the guiding channels at the dielectric-air interface plane. This type of arrangement still suffers from the defficiencies resulting from non-uniform excitation of the electro-optic material forming the guiding channels. More importantly, as the guiding channels possess a weak lateral confinement due to a small differential refraction index existing between the guiding channels and the surrounding dielectric medium, the electrode-spacing (and as a consequence, the spacing of the guiding channels) cannot be reduced to generate a larger electric field for a given level of applied voltage since reduced spacing increases the optical coupling between the guiding channels in the areas where they are to be well isolated. In all electrode configurations in the prior art, the electrodes are always placed at the dielectric-air interface. This is even the case for the slightly-ridged waveguide, which has the electrodes positioned on top of the guiding channels.

### SUMMARY OF THE INVENTION

The present invention provides a novel electrode configuration in the design of wideband high-speed optical modulators and switches. The electrode configuration maximizes the microwave traveling wave field intensity, its transverse spatial uniformity within the light guiding channels and provides superior optical matching performance while maintaining a high level of optical channel isolation.

Embodiments of the invention include devices for performing optical signal switching, other optical routing functions, and/or light intensity modulation for high-speed external modulator applications or in optical phase-shifter while substantially improving the figure-of-merit of such optical devices in terms of reduction in the required Voltage-Length product (V_{π}×L). Preferred applications include optical switches, couplers, intensity modulators and phase shifters based on Lithium Niobate Oxide (LiNbO3), although the present invention is applicable to any optical device requiring efficient application of external voltage to setup electric field for changing the electro-optic characteristics (index of refraction) of an electro-optic material.

In the present invention, the externally induced electric field is set up via a plurality of electrodes, which are strategically embedded in the crystal/dielectric material surrounding the waveguide channel(s), with appropriate shape/thickness and penetration level depending upon design requirements. This permits partial or complete straddling of the channel(s); as opposed to surface-mount electrodes of prior art, which rely on penetration of the external electric field in the crystal or dielectric material. This enhanced proximity, for a given level of applied voltage, allows the excitation of much stronger electric field in the vicinity of the light carrying waveguide channel(s). Furthermore, this stronger field is, to a large extent, spatially uniform over the waveguide channel(s), resulting in an overall larger effective change in the refractive index experienced by the optical fields. Such embedded electrode geometry, if desired, can be used to advantage toward substantially reducing the inter-channel coupling for a given level of inter-channel spacing where such isolation is required for device performance or reduction of inter-channel spacing to reduce the overall size of the optical device, which may use a multitude of optical switches and/or modulators.

The improved physical confinement of the optical waveguide channels and branches by the embedded electrodes will make it possible to significantly reduce the possibility of light attenuation and escape at channel discontinuities and curved sections. Consequently, the required channel discontinuities and curved sections called for by the design of an optical device can be configured with larger angles and smaller radii of curvature to reduce the overall size of the optical device.

Furthermore, the proximity configuration and the resulting efficiency of the embedded electrodes facilitate impedance and phase matching in a traveling-wave electrode configuration for external optical modulators. This in turn permits achieving higher modulation speeds.

Accordingly, the present invention provides a novel design of electrodes and method of excitation of the electro-optic material. Vertical field configurations can be assumed by one electrode placed on top of the guiding channel at the dielectric-air interface and one embedded in the dielectric below the channel. However, for ease of manufacturing and also in order not to preclude the option for partial confinment of the channel, the electrodes are most convenint to be placed in a horizontal field arrangement.

According to the present invention, after formation of the guiding channel(s) in the dielectric by known manufacturing methods( for instance in-diffusion or annealed proton exchange APE for LiNbO3, rib/ridged waveguides or other methods of creation of buried waveguides), the surface of the crystal/dielectric is etched with the desired pattern for width, length and penetration depth of the electrodes by known techniques (for LiNbO3 for instance, dry-etching using electron cyclotron resonance etching or wet etching or ion milling techniques). The electrodes (for instance, the signal electrode in the center and the ground electrodes on the sides for a push-pull arrangement) are then deposited as a single or multi-layered configuration using known manufacturing techniques. A thin layer of optically transparent insulating material (buffer layer) such as SiO2 or low-k dielectric material such as SiLK (ε=2.65) can be placed on the surface of the etched dielectric before deposition of a set of single or multi-layered electrodes towards controlling conductor losses and conductor/optical mode interaction and thermal and DC bias stability. Furthermore, a thin adhesion layer for electrods such as Ti can be deposited before placement of the electrods. The electric field so set up, is highly uniform around the guiding channel(s). As the optical channels are now well isolated from each other, the separation distance of the signal and ground electrodes is no longer dictated by the inter-channel isolation considerations of the guiding channels. The channels can now be placed closer to each other. The electrode separation distance for a guiding channel can be decided based upon the design considerations for electric field intensity, impedance matching and other design tradeoff parameters rather than optical coupling considerations.

As the electrode gap becomes narrower to increase the electric field intensity between the source and ground electrode, the phase and impedance matching between the optical field and applied microwave field will be more difficult to achieve. This difficulty can be overcome by placing two floating electrodes on top of the rib/riged waveguides. Unlike active electrodes which are connected to DC or time varying voltage source, the floating electrodes are simply placed over the guiding channels with no connection to any external field source. The low-k dielectric material such as SiLK instead of SiO2 filled between the central signal electrode and ground electrodes is also helpful for the matching. With such design features, the strong electric field intensity combined with the additional floating electrodes and low-k material filling render a very broadband and low drive voltage operation for these electro-optic waveguide devices.

### BRIEF DESCRIPTION OF THE DRAWINGS

The Preferred embodiments of the present invention will now be described in detail in conjunction with the annexed drawings, in which:

FIG. 1a illustrates field excitation of waveguides with surface-mounted thin electrodes, the electric field being principally horizontal over the channel-waveguides;

FIG. 1b illustrates field excitation of waveguides with surface-mounted thin electrodes, the electric field being principally vertical over the channel-waveguides;

FIG. 1c illustrates field excitation of waveguides with surface-mounted thick electrodes, the electric field being principally horizontal over the channel-waveguides;

FIG. 1d illustrates field excitation of slightly-ridged waveguides with surface-mounted thick electrodes, the electric field being principally vertical over the channel-waveguides;

FIG. 1e illustrates field excitation of slightly-ridged waveguides with surface-mounted multi-layered thick electrodes, the electric field being principally vertical over the channel-waveguides;

FIG. 1f illustrates field excitation of slightly-ridged waveguides with surface-mounted multi-layered tapered thick electrodes, the electric field being principally vertical over the channel-waveguides;

FIG. 2 illustrates the electrode design of the present invention embracing the channel-waveguides on the two sides, the electric field being horizontal over the channel-waveguides;

FIG. 3 illustrates the electrode design of the present invention embracing the channel-waveguides and the buffer layer on the two sides, the electric field being horizontal over the channel-waveguides;

FIG. 4 illustrates the electrode design of the present invention embracing the channel-waveguides and the buffer layer on the two sides, the electrodes partially extruding beyond the dielectric-air interface, the electric field being horizontal over the channel-waveguides;

FIG. 5 illustrates the electrode design of the present invention embracing the channel-waveguides and the buffer layer on the two sides, the tapered electrodes partially extruding beyond the dielectric-air interface, the electric field being principally horizontal over the channel-waveguides;

FIG. 6 illustrates the electrode design of the present invention embracing the channel-waveguides and the low-k material buffer layer on the two sides and top of the channel waveguides, with tapered active electrodes partially protruding above the dielectric-air interface and floating electrodes not connected to external field sources disposed on top of the low-k material buffer layer/channel waveguides;

FIG. 7(a) illustrates an application of the present invention to provide an optical intensity modulator;

FIG. 7(b) illustrates an application of the present invention to provide an optical switch;

FIG. 8(a) illustrates the present design in FIG. 7(a) with the y-junction branch replaced by an 1×2 Multimode Interference (MMI) device;

FIG. 8(b) illustrates the present design in FIG. 7(b) with the coupling region replaced by a 2×2 MMI device.

FIG. 9(a) illustrates the change in microwave index and impedance with embedded electrodes on X-cut LiNbO3 optical modulator and with surface electrodes on Z-cut LiNbO3 for 30 GHz operation;

FIG. 9(b) illustrates the change in microwave index and impedance due to incorporation of a buffer layer of two different dielectric constants (without floating electrodes);

FIG. 9(c) illustrates the change in microwave index and impedance with and without the floating electrodes (SiLK used as dielectric buffer layer);

FIG. 10(a) illustrates the change in microwave index and impedance as a function of the width of the floating electrodes (SiLK used as dielectric buffer layer and the thickness of the floating electrodes being 0.5 μm); and

FIG. 10(b) illustrates the change in microwave index and impedance as a function of the thickness of the floating electrodes (SiLK used as dielectric buffer layer and the width of the floating electrodes being 5 μm).

### DETAILED DESCRIPTION OF THE PREFERRED EMBODIMENTS

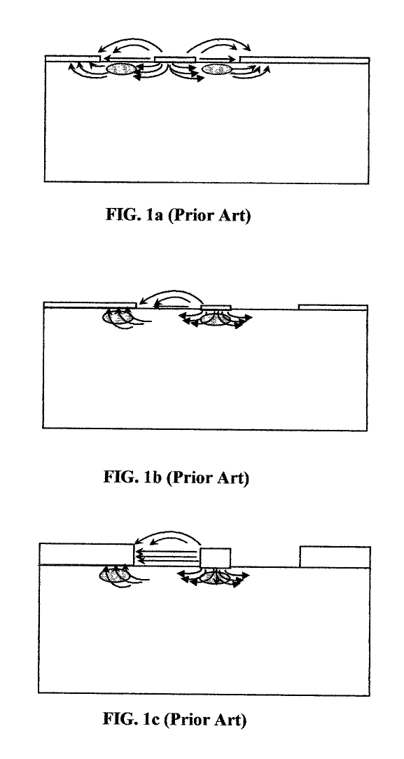

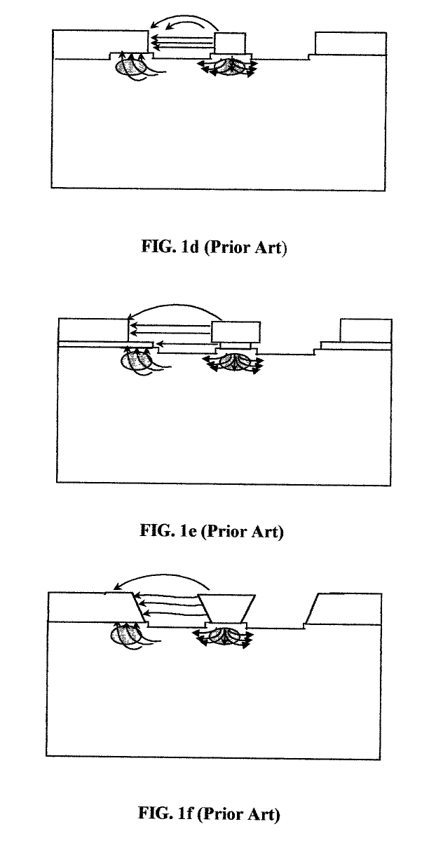

FIGS. 1a to 1d illustrate the electrode designs of the prior art. In these figures, the channel waveguides are represented by ellipses located within the dielectric region but in close proximity with the dielectric-air interface. The electrode configuration in these figures is co-planar symmetric (FIG. 1a) and asymmetric (FIGS. 1b to 1f) microstrip design. The electrodes (thin layers in FIGS. 1a and 1b, and thick layers in FIGS. 1c and 1d) are placed at the air-dielectric interface surface on the dielectric substrate. The external electric field set up by the application of a constant (DC) or time-varying voltage across the electrodes possesses a non-uniform spatial characteristic in terms of magnitude (maximum field for time varying case) and direction. As schematically represented by arrows, the electric field so set up is principally vertical under the electrodes and away from the edges (normal to the electrode surface). As one approaches the dielectric-air interface within the two edges of the adjacent electrodes, the electric field is principally horizontal.

FIG. 1a represents a configuration that places the channel-waveguides, relative to the electrodes, in a fashion that are excited principally by horizontally directed electric field. FIG. 1b represents a configuration that the channel waveguides are excited principally by vertically directed electric field. FIG. 1c is the same as FIG. 1b but with thicker electrodes. FIG. 1d is similar to FIG. 1c but the channel waveguides are slightly ridged. FIG. 1e shows a multi-layered structure for the electrodes and FIG. 1f depicts a configuration with a slight taper angle in the vertical direction.

In all of the electrode configurations in the prior art (FIGS. 1a to 1f), the electrodes are always placed at the dielectric-air interface. This is even the case for the slightly-ridged waveguide, which has the electrodes positioned on top of the guiding channels.

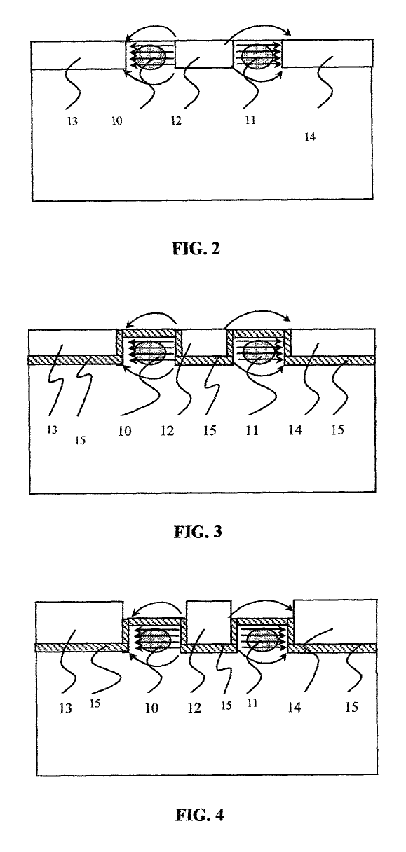

FIGS. 2-8 illustrate some of the embodiments and applications of this invention. FIG. 2 depicts the embedded thick electrode structure in the crystal/dielectric material on either side of the channel-waveguides. As shown, there are two channel-waveguides 10 and 11 with one embedded electrode 12 in between and two outer electrodes 13 and 14. The external electric field so set up is highly uniform in terms of its spatial distribution and polarization. The channel-waveguides experience a strong uniform and horizontally directed field. FIG. 3 illustrates a similar configuration but with a thin layer 15 of insulating material (buffer layer) such as SiO2 sandwitched between the surface of the etched dielectric and the electrodes for the purpose of reducing conductor losses and controlling conductor/optical mode interaction and thermal and DC bias stabilization of the substrate material.

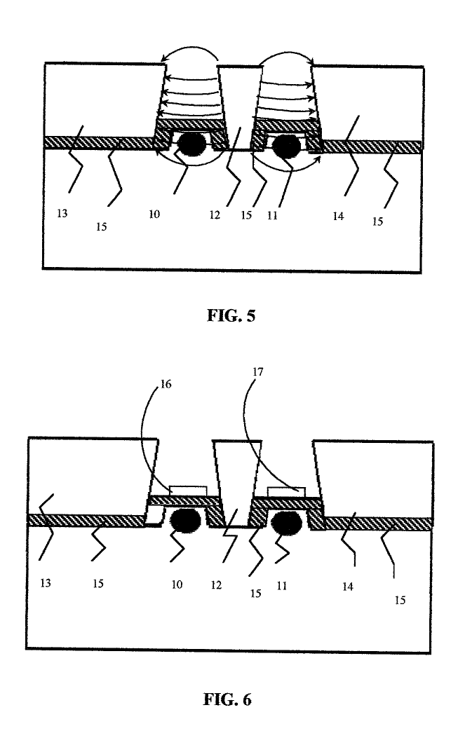

FIG. 4 is a variation of the structure in FIG. 3. Here the electrodes 12, 13 and 14 protrude above the dielectric-air interface in the direction of the latter. Such protrusion can be beneficial in optimizing certain design parameters given a defined level of device performance. FIG. 5 is a variation of the FIG. 4 structure. In this geometry, the electrodes 12, 13, and 14 possess a small angular taper in the vertical direction to yet offer further flexibility in the design and optimization of the overall device performance. FIG. 6 is a variation of the FIG. 5 structure, wherein floating electrodes 16, 17 are placed on top of the buffer layer/channel waveguides. Such design can be beneficial in matching the phase and impedance resulting in a broadband and low drive power performance.

The fundamental character of the configurations presented by FIGS. 2-6 is that the waveguide channels are completeley embraced by the partially or fully embedded electrodes, hence experiencing a strong and spatially uniform external field with prinicipally pure electric field polarization. Moreover, the impedance and phase can be matched by both applying the floating electrode 16 or 17 with a flexible dimension and applying a low-k (low dielectric constant) material as a buffer layer placed on top of the channel waveguides and filled inbetween the central source electrode and ground electrodes. A further variation of these configurations is the partial confinement of the waveguide channel by the active eletrodes if certain levels of coupling between the channels are mandated by the specific design at hand. The level of interchannel isolation (cross-talk) depends on the level of penetration of the electrodes and the separation distance of the guiding channels.

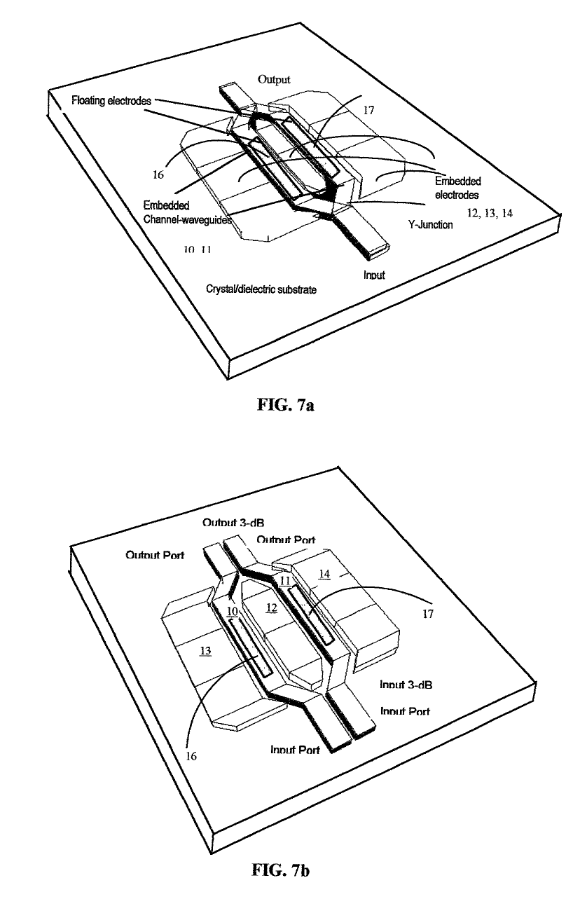

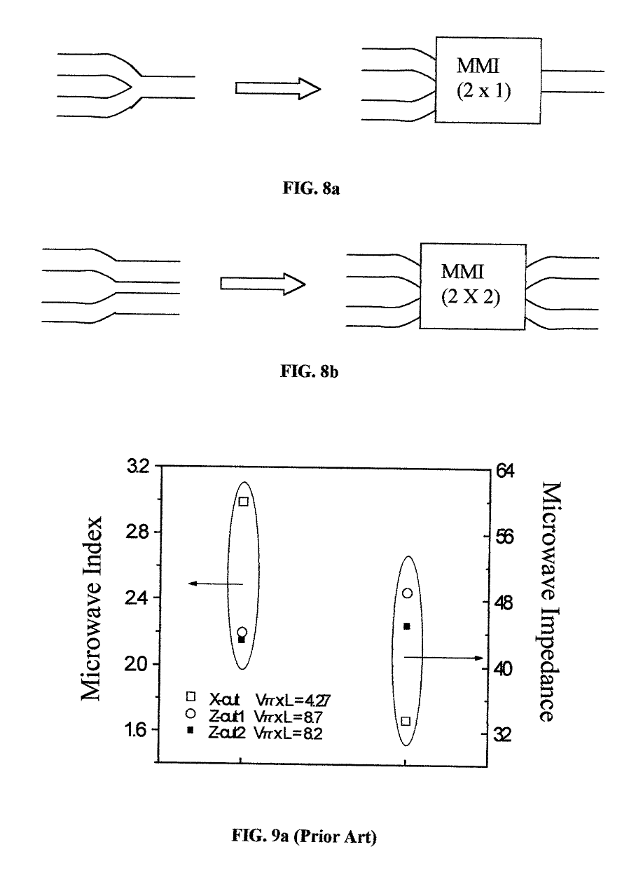

FIG. 7(a) depicts the isometric view of the application of this invention in devising an optical external modulator. The channel-waveguides 10 and 11 and the electrudes 12, 13, and 14 are embedded in the crystal/dielectric substrate. The light entering from the input junction is split in two equal parts (symmetric y-junction). For a coplanar symmetric electrode arrangement such as FIG. 7(a), if a push-pull excitation strategy is adopted, the center electrode is hot-electrode and the two side electrodes will be connected to each other and used as common (or reference) electrodes. The voltage source will be connected between the hot electrode and the common electrodes. This arrangement will set up an external electric field, which possesses opposite polarization in the two parallel channel waveguides (see FIG. 3 which depicts an x-z plane cut of FIG. 7(a) half-way through the structure). The change in the refraction index, and hence the phase of the optical wave, is a function of the peak magnitude of the applied voltage, the separation distance of the hot versus common electrodes, the length of the electrodes in the y direction (active region) and the spatial uniformity of the field in the guiding channels. The higher the magnitude and spatial uniformity of the electric field and the longer active region, the larger is the relative phase difference experienced by the two components of the light passing through the channel waveguides. In the absence of externally applied field, the two components of the optical wave will add coherently in the output y-junction. If the active region is selected in such a way that, for a given level of externally applied voltage, the differential phase is 180 degrees, the coherent addition of the two components of the optical wave arriving at the output y-junction would result in creation of a second-order optical mode that cannot be supported by the single-mode output junction. Hence, light is radiated into the substrate and the transmitted light is minimum. For a time varying external voltage source, this results in intensity modulation of the input light at the output port. In addition, the y-junction branch can be replaced by 2×1 or 2×2 multimode interference (MI) device as shown in FIG. 8(a), providing a more flexible fabrication process with superior performance.

FIG. 7(b) depicts the isometric view of the application of this invention in devising an optical switch. The channel-waveguides 10 and 11 and the electrudes 12, 13, and 14 are embedded in the crystal/dielectric substrate. The light entering from input port 1, is split into two equal parts at the input 3 dB coupler. The two components travel along the parallel waveguide channels. In the absence of any externally applied electric field, the light components combine back through the ouput 3-dB coupler, resulting in maximum light in output port minimum light in output port 2. With an external field and for 180 degrees relative phase shift between the channel-waveguides, the light completely swiches over from line 1 to line 2. Instead of using the 3-dB proximity couplers in the application of FIG. 7(b), multimode interference (MMI) couplers, as shown in FIG. 8(b), can also be used in the present design with relaxed fabrication process and high tolerance to polarization and wavelenth variations.

The effectiveness of the proposed electrode configuration in this invention in terms of a high degree of spatial uniformity of the external electric field, guiding channel isolation and larger field magnitude, the length of the active region can be reduced substantially (to one half and more) for a given level of externally applied voltage. Alternatively, for the same length for the active region, the voltage can be reduced by the same factor.

The resulting savings in channel length has the added advantage that now, the aggregate deleterious effects of mismatch between the traveling-wave microwave modulating signal and the optical wave in a high-speed optical modulator is less pronounced. For the same reason, the conductance losses of the electrodes and dielectric losses of the substrate are much smaller. This results in a higher cutoff frequency for the modulating signal in an optical switch or intensity modulator and much lower attenuation for lower speed applications.

In the design of optical y-junctions and 3-dB couplers in the prior art, the branches of the y-junctions or 3-dB couplers generally have a very slow flare angle. This is in order to ensure that the optical wave passing through will not experience a sudden discontinuity, which is generally accompanied by severe optical mode attenuation and escape. In most applications, these branches have to be connected to two parallel guiding channels (such as interferometric modulators considered here as examples), which by themselves will have to be largely separated to control inter-channel cross-talk caused by evanescent mode coupling In the prior art designs, the branches of the small flare yjunctions and 3-dB couplers would have to be inconveniently long to make such mating possible.

In the present invention, the embedded electrodes already isolate the optical channel-waveguides. By extending the hot and common electrodes in the proximity of input and output y-junctions and the 3-dB couplers, the coupling between the branches can also be controlled. This design flexibility can be productively used in two ways. If a smaller physical size in the lateral direction is desired, the branches of y-junctions and 3-dB couplers can assume a very gradual flaring angle. But now, the length of the branches can be significantly reduced relative to prior art as the parallel channel-waveguides can now be positioned much closer to each other due to the isolation offered by the embedded electrodes. The reduction in lateral dimension, coupled with a much shorter active region required for a given level of differential phase, substantially reduce the physical size of the optical intensity modulator or switch. This volumetric saving is a key performance parameter in the design of optical devices, which integrate a large number of switches and/or modulators.

Alternatively, for optical devices for which the longitudinal dimension is a design driver, the branches of the junctions and 3-dB couplers can assume a relatively large flare angle with less concern for light attenuation and escape at such rapid transitions. This can substantially reduce the lateral size of the y-junctions or 3-dB couplers. For large cross-connect optical integrated circuits utilizing cascading switches, such savings can be very beneficial.

For optical devices and integrated circuits for which low voltage, power dissipation and/or power consumption are the key performance parameters (such as dense optical integrated circuits), the electrode design proposed in this invention can be beneficially used to substantially reduce the level of the required external voltage source, the dissipated power and the required prime power.

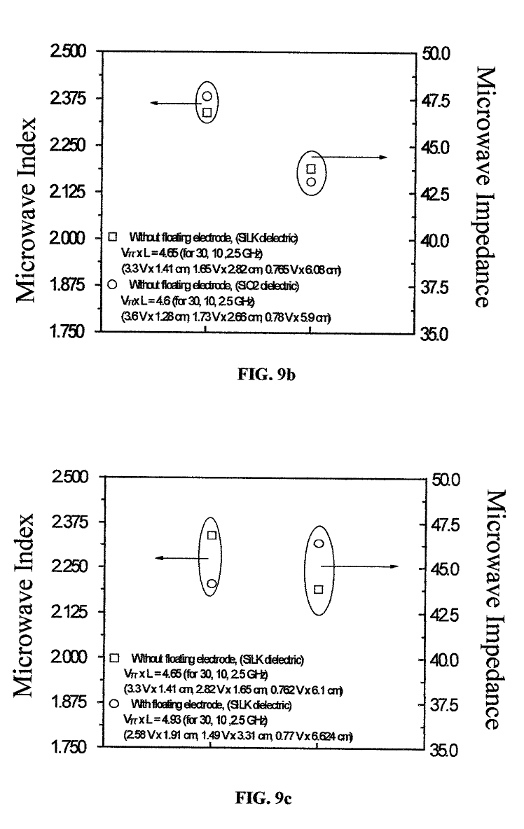

The above mentioned improvements, which are the results of improved impedance and phase matching, for example, optical modulators, are illustrated in FIGS. 9a, 9b and 9c. By way of example, a Ti: LiNbO3 optical modulator (symmetric Mach-Zehnder Interferometer) is designed for operation at data rates at a 3-dB bandwidth of 30 GHz (other possible data rates could be 10 GHz and 2.5 GHz).

FIG. 9a shows the microwave impedance and microwave index in two examples of prior art optical modulators having thick electrodes on the crystal surface situated on the in Z-cut configurations (thick electrodes would be on the sides of the optical channels in X-cut configurations). They exhibit a V_{π}×L of greater than 8 volt-cm for 30 GHz operation. The two examples of such designs are provided in FIG. 9a under the labels Z-cut1 and Z-cut2. An X-cut arrangement with electrodes completely embracing the guiding channels (the subject of an aspect of this invention) can substantially reduce V_{π}×L (4-5 volt-cm) by virtue of the fact that a larger and more uniform external electric field is set up within the guiding channels (FIG. 9a, X-cut). However, this increased efficiency in setting up the external field is partially lost due to a severe mismatch caused by an increase in the microwave effective index (relative to the optical effective index) and a reduction of the microwave impedance consequential to the electrodes' penetration into the crystal. The deleterious effect of this mismatch is a reduction in the maximum 3-dB microwave active length of the electrodes due to “walk-off” effect. This reduced length can substantially increase the required V_{π} and, as a consequence, the RF voltage required for inducing a 180-degree phase shift between the arms of the Mach-Zehnder modulator at the required operating frequency. The increase in voltage could put a significant burden on the design of the “driver” stage for the modulator at high data transmission rates.

As discussed earlier, to mitigate this mismatch, two means are available: a) reduce the dielectric constant around the guiding channels by introducing a buffer layer, and b) introduce “floating electrodes”.

For the same electrode geometry as the one used in FIG. 9a (X-cut), FIG. 9b illustrates the effects of introducing a dielectric buffer layer surrounding the optical channels n the microwave effective index and impedance for two different dielectric materials. The corresponding V_{π}×L are also shown. As may be seen, the impact on microwave matching (effective index and impedance) is significant. This improved matching increases the maximum active length and, as a consequence, reduces the RF drive voltage. The flexibility in reducing the RF voltage requirement of the driver stage. A small degradation of V_{π}×L is also evident in this case.

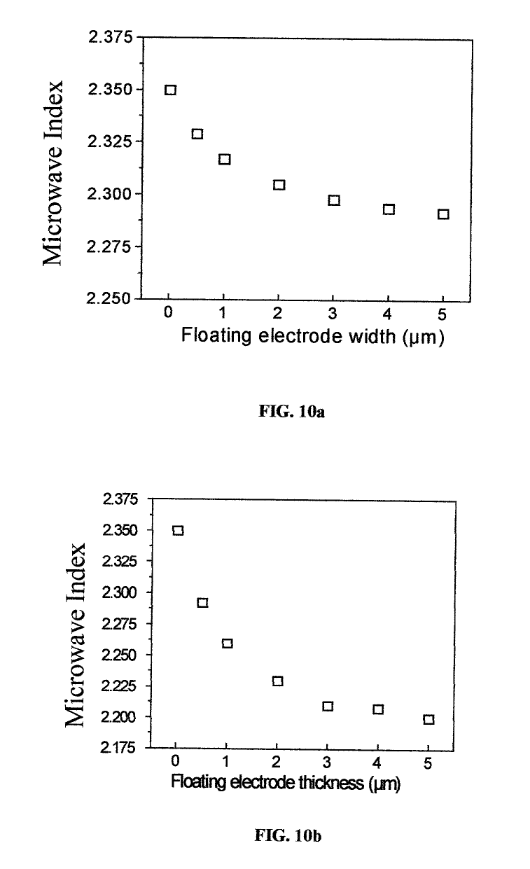

FIGS. 10a and 10b show the impact of the variation of the dimensions o the floating electrodes. FIG. 10a illustrates the change in microwave index and impedance as a function of the width of he floating electrodes (SiLK is used as dielectric buffer layer) with the thickness of the floating electrodes set at 0.5 μm. FIG. 10b illustrates the change in microwave index and impedance as a function of the thickness of the floating electrodes. (SILK is used as dielectric buffer layer) with the width of the floating electrodes set at 5 μm.

What is claimed is:

1. An optical planar waveguide device having at least one planar waveguide, comprising:
at least first and second electrodes, the first adjacent a predetermined length section of the waveguide on one side thereof, and the second opposite the first one on the other side of the waveguide; and said first and second electrodes having a thickness between being approximately equal to the thickness of the waveguide and being equal to several times that thickness; and said first and second electrodes being partially coplanar with said waveguide.

2. The optical planar waveguide device as defined as described in claim 1, said first and second electrodes adapted to have a modulating electrical signal applied thereacross to change a characteristic of said predetermined length section of said waveguide during application of said modulating electrical signal.

3. The optical planar waveguide device as defined in claim 2, further comprising insulating buffer layers intermediate at least said first/second electrodes and the waveguide section.

4. The optical planar waveguide device as defined in claim 1, wherein said first and second electrodes protrude above the top of the waveguide in their thickness, dimension.

5. The optical planar waveguide device as defined in claim 2, wherein said first and second electrodes protrude above the top of the waveguide in their thickness, dimension.

6. The optical planar waveguide device as defined in claim 3, wherein said first and second electrodes protrude above the top of the waveguide in their thickness, dimension.

7. The optical planar waveguide device as defined in claim 3, further comprising a floating (not electrically connected) electrode disposed on top of said insulating layer above said planar waveguide.

8. The optical planar waveguide device as defined in claim 4, further comprising a floating (not electrically connected) electrode intermediate protruding portions, above the top of the waveguides, of said first and second electrodes.

9. The optical planar waveguide device as defined in claim 5, further comprising a floating (not electrically connected) electrode disposed on top of said insulating layer above said planar waveguide.

10. The optical planar waveguide device as defined in claim 6, further comprising a floating (not electrically connected) electrode disposed on top of said insulating layer above said planar waveguide.

11. The optical planar waveguide device as defined in claim 7, said floating electrode having a width and a thickness of up to five micrometers.

12. The optical planar waveguide device as defined in claim 8, said floating electrode having a width and a thickness of up to five micrometers.

13. The optical planar waveguide device as defined in claim 9, said floating electrode having a width and a thickness of up to five micrometers.

14. The optical planar waveguide device as defined in claim 10, said floating electrode having a width and a thickness of up to five micrometers.
